(19) United States
(12) Patent Application Publication
(10) Pub. No.: US 2021/0166628 A1
(43) Pub. Date: Jun. 3, 2021

(54) A METHOD FOR DRIVING A DISPLAY PANEL, A DRIVING CIRCUIT, AND A DISPLAY APPARATUS

(71) Applicants: BOE TECHNOLOGY GROUP CO., LTD., Beijing (CN); Chengdu BOE Optoelectronics Technology Co., Ltd., Chengdu, Sichuan (CN)

(72) Inventors: Weiyun Huang, Beijing (CN); Tingliang Liu, Beijing (CN)

(73) Assignees: BOE TECHNOLOGY GROUP CO., LTD., Beijing (CN); Chengdu BOE Optoelectronics Technology Co., Ltd., Chengdu, Sichuan (CN)

(21) Appl. No.: 16/067,773

(22) PCT Filed: Dec. 14, 2017
(86) PCT No.: PCT/CN2017/116199

§ 371 Date: Jul. 2, 2018

(30) Foreign Application Priority Data
Jun. 9, 2017 (CN) 201710433073.3

(51) Int. Cl. G09G 3/3258; G09G 3/3291

(52) U.S. Cl. CPC G09G 3/3258; G09G 2320/0233; G09G 2310/0297; G09G 3/3291

(57) ABSTRACT

The present application discloses a method for driving a display panel including multiple groups of sub data lines and each group includes multiple sub data lines coupled to a corresponding data line via a mux device. The method includes providing multiple data signals originated from the voltage signal sequentially in time respectively to the multiple sub data lines in each group. The multiple data signals includes a first data signal characterized by a first pulse width being received at a first time by a first sub data line in the group and a second data signal characterized by a second pulse width larger than the first pulse width being received at a second time later than the first time by a second sub data line in the group. A data signal received earliest in time by a sub data line has a shortest pulse width.

### CROSS-REFERENCE TO RELATED APPLICATION

This application claims priority to Chinese Patent Application No. 2017104330713, filed Jun. 9, 2017, the contents of which are incorporated by reference in the entirety.

### TECHNICAL FIELD

The present disclosure relates to display technology, more particularly, to a method for driving a display panel for displaying images, a driving circuit thereof, and a display apparatus.

### BACKGROUND

Display apparatus is comprised of multiple pixels arranged in an array of matrix having multiple rows and columns. Each pixel includes multiple subpixels. For simplifying pixel structure of the display apparatus, a typical approach is to incorporate a max device in a driving circuit for providing multiple data signals from a source driver to multiple columns of subpixels of a same column of pixels to drive each corresponding pixel circuit containing a light emitting device to emit light for image display. This approach has some display quality issues such as non-uniform intensity and unwanted stripe lines in the images. An improvement to the display technique is desired.

### SUMMARY

In an aspect, the present disclosure provides a method for driving a display panel to display images. The display panel includes multiple groups of sub data lines. Each group includes multiple sub data lines and is coupled to a corresponding data line via a mux device. Each sub data line is coupled to a pixel circuit. Each data line is coupled to a source driver which is configured to provide a voltage signal. The method includes providing multiple data signals originated from the voltage signal sequentially in time respectively to the multiple sub data lines in each group. The multiple data signals includes a first data signal characterized by a first pulse width being received at a first time by a first sub data line in the group and a second data signal characterized by a second pulse width being received at a second time by a second sub data line in the group. The first time is earlier than the second time and the first pulse width is smaller than the second pulse width.

Optionally, each group includes n number of sub data lines. n is a natural number greater than 2. The method of providing multiple data signals includes providing an (i−1)-th data signal having a pulse width t to an (i−1)-th sub data line of the n number of sub data lines followed by providing an i-th data signal baying a pulse width tᵢ to an i-th sub data line of the number of sub data lines, tᵢ>tᵢ₋₁, 1>i≤n. The first data signal provided at an earliest time to a first sub data line has a shortest pulse width tᵢ among the n number of data signals provided respectively to the n number of sub data lines.

Optionally, the i-th data signal, sequentially from 1 to n, is configured to induce a charging process to charge a gate of a driving transistor in the pixel circuit coupled to the i-th sub data line in a charging time equal to the i-th pulse width tᵢ followed by an extra charging process by released charges from a parasitic capacitance of the i-th sub data line. The method of providing the multiple data signals sequentially from 1 to n includes controlling the charging time of each data signal sequentially from 1 to n to obtain a voltage level at the gate of the driving transistor substantially same in each pixel circuit after the charging process induced by the n-th data signal ends.

Optionally, the providing the multiple data signals sequentially from 1 to n further includes setting tᵢ/tᵢ₋₁ equal to a ratio of a first charging current in a sub data line induced by the source driver over a difference of the first charging current and a second charging current in the sub data line induced the released charges from the parasitic capacitance associated with the sub data line.

Optionally, the method of setting tᵢ/tᵢ₋₁ includes calculating the first charging current and the second charging current for each pixel circuit coupled to the i-th sub data line based on simulations.

Optionally, the n is smaller than 7.

Optionally, the method of providing multiple data signals includes configuring the mux device as n number of switches each of which has a first terminal coupled to the data line and a second terminal coupled to a corresponding sub data line. The method of providing multiple data signals further incudes turning on a first switch of the n number of switches for a first duration to pass the first data signal having the first pulse width equal to the first duration and a pulse height equal to the voltage level provided by the source driver to the first sub data line. The method of providing multiple data signals also includes subsequently turning on a second switch of the n number of switches for a second duration to pass the second data signal having the second pulse width equal to the second duration and a pulse height equal to the voltage level provided by the source driver to the second sub data line. The first duration is controlled to be shorter than the second duration.

Optionally, the extra charging process applied to a pixel circuit through the i-th sub data line starts from an end time of the i-th pulse width tᵢ of the i-th data signal and ends with an extra time period after an end of a last pulse width tᵢ of the n-th data signal applied to a pixel circuit through the n-th sub data line in a same group.

Optionally, the extra time period is 0.

In another aspect, the present disclosure provides a driving circuit for driving a display panel for displaying images. The display panel includes multiple groups of sub data lines. Each group includes multiple sub data lines respectively coupled to a data line. Each sub data line is coupled to a pixel circuit. The driving circuit includes a source driver configured to provide a voltage signal. The driving circuit further includes multiple data lines each of which connects to the source driver to receive a voltage corresponding to the voltage signal. Additionally, the driving circuit includes multiple max devices corresponding to the multiple data lines. Each mux device includes an input terminal coupled to a corresponding one of the multiple data lines, multiple output terminals each of which coupled to a sub data line, and multiple control terminals corresponding to the multiple output terminals. The driving circuit further includes a control sub-circuit configured to provide control signals to the multiple control terminals of the multiple mux devices to make the input terminal of each of the multiple mux devices being connected to the corresponding multiple output terminals for corresponding durations of time. For each mux device, the control sub-circuit is configured to provide multiple control signals sequentially to the corresponding multiple control terminals. A first one of the multiple control signals received earliest in time by one of the multiple control terminals has a shortest duration of time.

Optionally, each mux device includes n number of control terminals. n is a natural number greater than 2. The multiple control signals include an (i−1)-th control signal provided to an (i−1)-th control terminal with a duration tᵢ followed by an i-th control signal provided to an i-th control terminal with a duration tᵢ, tᵢ>tᵢ₋₁, 1<i≤n. The first control signal applied at an earliest time to a first control terminal has a shortest duration tᵢ among the n number of control signals applied respectively to the n number of control terminals.

Optionally, n is smaller than 7.

Optionally, the each mux device includes an input terminal configured to receive the voltage from a data line. An i-th output terminal of the mux device is connected to the input terminal by the i-th control signal with the duration tᵢ to send an i-th data signal with a pulse width equal to the duration tᵢ and a pulse height equal to the voltage to an i-th sub data line.

Optionally, the i-th data signal, sequentially from 1 to n, is to induce a charging process to charge a gate of a driving transistor in the pixel circuit coupled to the i-th sub data line in a charging time equal to the i-th pulse width tᵢ followed by an extra charging process by released charges from a parasitic capacitance of the i-th sub data line. The control sub-circuit is configured to provide multiple control signals to control the charging time of each data signal sequentially from 1 to n to obtain a same voltage level at the gate of the driving transistor in each pixel circuit after the charging process induced by the n-th data signal ends.

Optionally, the extra charging process applied to a pixel circuit through the i-th sub data line starts from an end time of the i-th pulse width tᵢ of the i-th data signal and ends with an extra time period after an end of a last pulse width t of the n-th data signal applied to a pixel circuit through the n-th sub data line in a same group.

Optionally, the control sub-circuit controls durations of multiple control signals sequentially from 1 to n by setting tᵢ/tᵢ₋₁ equal to a ratio of a first charging current in a sub data line induced by the source driver over a difference of the first charging current and a second charging current in the sub data line induced by the released charges from the parasitic capacitance associated with the sub data line.

Optionally, the first charging current and the second charging current are obtained based on simulations.

In yet another aspect, the present disclosure provides a display apparatus including a display panel and a driving circuit described herein. The display panel includes multiple groups of sub data lines. Each group includes multiple sub data lines. The driving circuit includes a mux device having multiple output terminals respectively coupled to the multiple sub data lines.

Optionally, the driving circuit includes a control sub-circuit configured to provide multiple control signals sequentially to control multiple data signals to be sent to corresponding multiple sub data lines. One of the multiple data signals firstly received by one of the multiple sub data lines has a shortest pulse width.

Optionally, the display panel is an organic light-emitting diode display panel.

### BRIEF DESCRIPTION OF THE FIGURES

The following drawings are merely examples for illustrative purposes according to various disclosed embodiments and are not intended to limit the scope of the present disclosure.

FIG. 1 is a schematic diagram of a driving circuit of an organic light-emitting diode PLED) display panel in related art.

FIG. 2 is a timing diagram of operating the driving circuit according to a conventional method.

FIG. 3 is a charging process associated with a pixel circuit when operating the driving circuit.

FIG. 4 is a timing diagram of operating the driving circuit according to an embodiment of the present disclosure.

FIG. 5 is a schematic diagram of a display apparatus according to some embodiments of the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

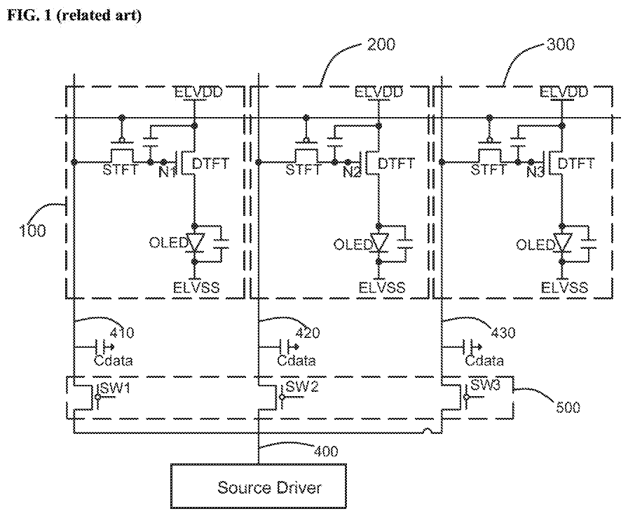

FIG. 1 is a schematic diagram of a typical driving circuit for an existing OLED display panel. Referring to FIG. 1, the display panel includes multiple pixels arranged in a matrix of multiple rows and columns. Each pixel includes three subpixels, e.g., a first subpixel 100, a second subpixel 200, and a third subpixel 300. Each subpixel is characterized by a pixel circuit including at least a driving transistor DTFT, a switch transistor STFT, and an organic light-emitting diode OLED. The driving transistor DTFT has a gate coupled to a node N1 (in the first subpixel 100), a drain coupled to high voltage supply ELVDD, and a source coupled to a first terminal of the OLED. The OLED has a second terminal coupled to a low voltage supply ELVSS. The switch transistor STFT controls a data signal to be applied to the node N1 following a certain timing operation to induce a current passing through the OLED in an emission period to emit light.

Referring to FIG. 1, a column of pixels corresponds to one data line 400. A column of subpixels corresponds to one sub data line. For example, the first subpixel 100 is coupled to a first sub data line 410, the second subpixel 200 is coupled to a second sub data line 420, and the third subpixel 300 is coupled to a third sub data line 430. A mux device 500 includes an input terminal coupled to the data line 400 and three output terminals respectively connected to the first sub data line 410, the second sub data line 420, and the third sub data line 430. The data line 400 is configured to transport data signals from a source driver. Optionally, the mux device 500 includes three switches SW1, SW2, and SW3 configured to make the data line 400 to be connected with the first sub data line 410, the second sub data line 420, and the third sub data line 430 in different time periods. In each respective time period, one sub data line receives a data signal via the mux device 500 and the data line 400 originated from the source driver. The data signal is applied to the pixel circuit of the corresponding subpixel to drive the OLED to emit light.

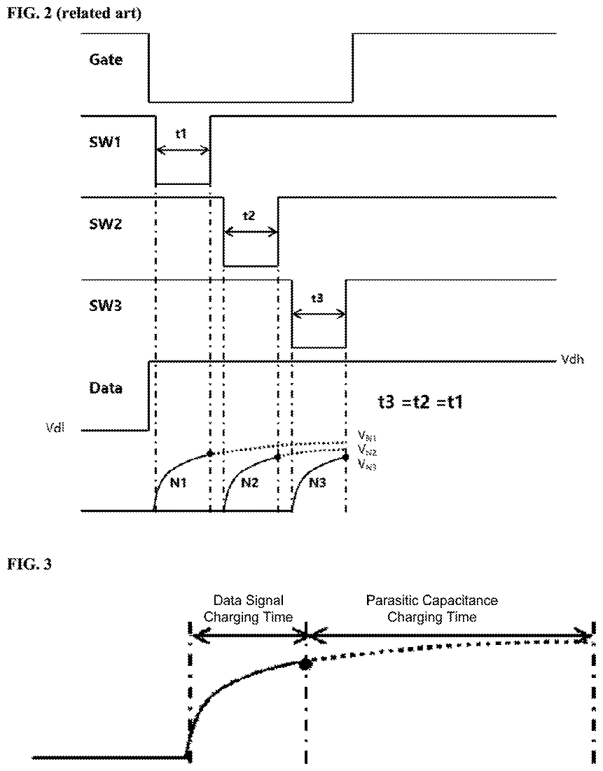

In particular, for each column of pixels, a duration of each time period for a mux device to pass a data signal from the data line to each sub data line is the same. FIG. 2 is timing diagram of operating the driving circuit according to a conventional method. In the timing diagram, the time period for providing a data signal to the first subpixel 100 via the first sub data line 410 is t1. The time period for providing a data signal to the second subpixel 200 via the second sub data line 420 is t2. The time period for providing a data signal to the third subpixel 300 via the third sub data line 430 is t3. Here t1=t2=t3. Referring FIG. 1, each switch (SW1, SW2, or SW3) in the mux device 500 is a P-type transistor. Thus a control signal having a low voltage pulse would turn it on to pass a data signal from the data line 400 to a corresponding sub data line (410, 420, or 430). The pulse width of the control signal is equal to the time period for passing the data signal from the data line to the corresponding sub data line, i.e., t1, t2, or t3, which is also the pulse width of the corresponding data signal.

It has been known that the data signal is inducing a charging process applied to the gate (i.e., node N1) of the driving transistor DTFT of the pixel circuit (e.g., pixel circuit 100) at least in a partial operation cycle. In an example of a white color being displayed in a pixel, three subpixels need to emit light of three colors with a same emission intensity. But, after the respective charging processes at the node N1, N2, and N3 of the three pixel circuits (for subpixel 100, 200, and 300) over a same charging time, e.g., t1=t2=t3, it is found that voltage level at the gate of driving transistor DTFT in the three pixel circuits actually is different. In fact, V_{N1}>V_{N2}>V_{N3}. Different gate voltage results in different driving current through the respective OLED and correspondingly different emission intensity.

Accordingly, the present disclosure provides, inter alia, a method for driving a display panel for displaying images, a driving circuit in the display panel for performing the method, and a display apparatus thereof that substantially obviate one or more of the problems due to limitations and disadvantages of the related art.

The charging process of the data signals with a same pulse width through different sub data lines on different gates of the driving transistors of different pixel circuits result in different gate charged voltage levels such as V_{N1}, V_{N2}, and V_{N3}. At least one reason for this effect is because of an extra charge releasing process of a parasitic capacitance C_{data}. The parasitic capacitance is formed due to a superposition of the sub data line layout over other metal layers in a subpixel. The charge releasing process for the subpixel pushes the charged voltage level at the gate of driving transistor of the pixel circuit in the subpixel to be higher than that induced by the charging process applied to the subpixel. Each charge releasing process starts after the corresponding charging process, as shown in FIG. 3, for each subpixel and continues until the last charging process of the last data signal applied sequentially in a group ends. So, assuming all data signals having a same pulse width and accordingly with a same time constant for each charging process, the earlier in time a sub data line receives a data signal, the longer of the parasitic capacitance C_{data} charge releasing effect is applied to pushes the corresponding gate voltage level higher. In other words, for the gate of driving transistor in the first pixel circuit coupled to the first sub data line receiving the first data signal, its gate voltage level will be pushed to a highest level by a largest C_{data} charge releasing effect compared to other receiving a corresponding data signal in later time.

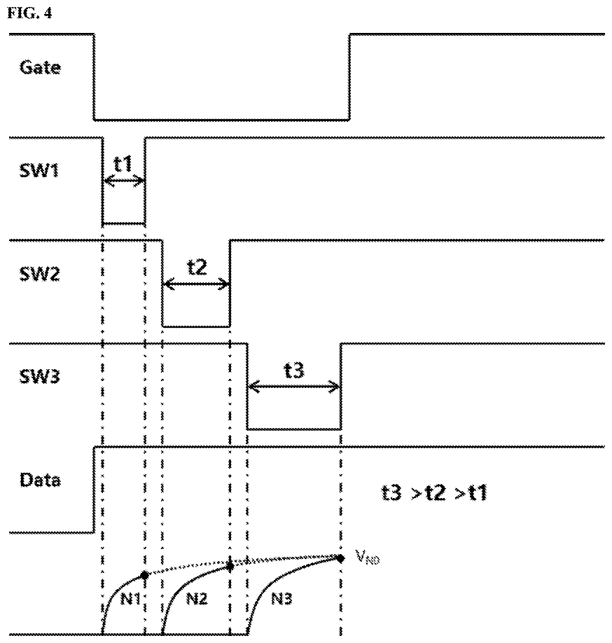

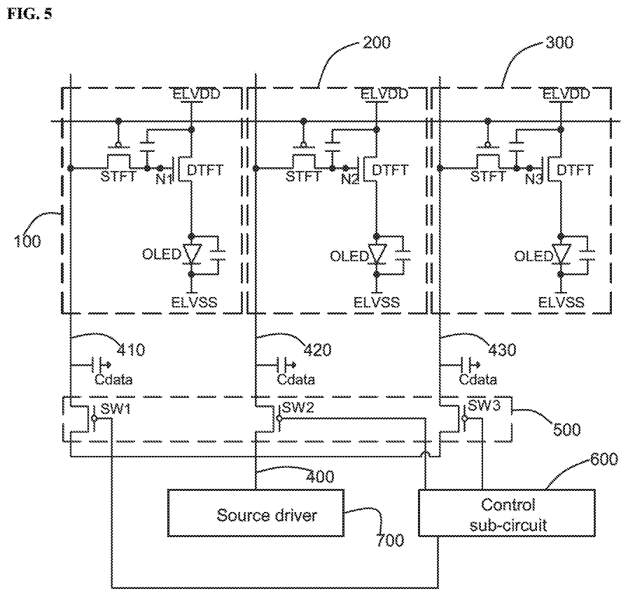

In one aspect, the present disclosure provides a method of driving a display panel for image display. The method is implemented by controlling duration of each time period for providing a data signal from the data line to each corresponding sub data line. The method is aimed to control a final gate voltage level to be a preset level substantially the same for all subpixels in a group. FIG. 4 is a timing diagram of operating the driving circuit according to an embodiment of the present disclosure, which is best of illustrating the method of driving a display panel. The display panel includes multiple groups of sub data lines. Each group includes multiple sub data lines respectively coupled to multiple pixel circuits of multiple subpixels. Each sub data line is coupled to a corresponding data line via a mux device. Each data line is coupled to a source driver which is configured to provide a voltage signal. Optionally, each pixel circuit includes at least a driving transistor controlling a light-emitting device to emit light for image display. Optionally, the light-emitting device is an organic light-emitting diode (OLED).

The method includes providing multiple data signals originated from the voltage signal sequentially in time respectively to the multiple sub data lines in each group. In particular, the multiple data signals includes a first data signal characterized by a first pulse width being received at a first time by a first sub data line in the group and a second data signal characterized by a second pulse width being received at a second time, by a second sub data line in the group. The first time is earlier than the second time and the first pulse width is smaller than the second pulse width.

In an embodiment, each group includes n number of sub data lines, where a is a natural number greater than 2. The method of providing multiple data signals sequentially in time includes providing an (i−1)-th data signal having a pulse width tᵢ>tᵢ₋₁ to an (i−1)-th sub data line of the n number of sub data lines followed by providing an i-th data signal having a pulse width tᵢ to an i-th sub data line of the number of sub data lines. Here tᵢ>tᵢ₋₁, 1<i≤n. Referring to FIG. 4, a group includes three sub data lines receiving respective three data signals. The respective pulse widths of the three data signals satisfy a condition as: t₃>t₂>t₁. In a specific embodiment, a first data signal provided at an earliest time to a first sub data line has a shortest pulse width t₁ among the n number of data signals provided respectively to the n number of sub data lines.

Since the first sub data line first in time receives a first data signal with a shortest pulse width tᵢ, the corresponding charging process is also a shortest one. But it corresponds to a longest extra charging process starting from the end of time period tᵢ to an end of a last (n-th) sub data line receives a last data signal with an optionally longest pulse width tₙ. The data signal provides a voltage level to the first sub data line fir charging a gate of driving transistor in a pixel circuit coupled to the first sub data line over a duration of tᵢ. After the charging process, an extra charging process induced by the parasitic capacitance starts to release charges to the first sub data line to push the voltage level above original one from the data signal. This process continues until reaching a final voltage level at the end of last data signal with the pulse width tₙ being applied to charge a gate of driving transistor in a pixel circuit coupled to the last (n-th) sub data line. This is also applicable to each of other sub data lines in a same group. For example, the second sub data line receives a second data signal after the first sub data line receiving the first data signal. The third sub data line receives a third data signal after the second sub data line receiving the second data signal, and so on.

In some embodiments, the method of providing multiple data signals sequentially in time includes controlling the corresponding pulse width of each data signal which also corresponds to the duration of corresponding charging process through the corresponding sub data line. The charging process and the extra charging process through each sub data line to the gate of driving transistor of the pixel circuit leads to a final voltage level at the corresponding gate. In an embodiment, the final voltage level is controlled to be substantially the same for all pixel circuits associated with a same group using the method described herein. Optionally, the final voltage level is substantially a preset voltage level for driving the pixel circuit to generate a current for driving the light-emitting device to emit a light with an expected intensity from each subpixel associated with the same group.

In some embodiments, controlling the charging duration through each individual sub data line is based on a charge conservation proximately satisfied for a charging process plus an extra charging process through the (i−1)-th sub data line and a charging process through the next i-th sub data line. The charge conservation can be expressed as: tᵢ×Iₚ=tᵢ₋₁×Iₚ+tᵢ×I_{Cdata}, where Iₚ is a first charging current generated in the sub data line by a corresponding voltage signal from the source driver (through the data line and the max device), and I_{Cdata} is a second charging current generated in the sub data line by the parasitic capacitance. Iₚ is depended upon the corresponding pixel circuit, transistor characteristics, and the voltage level provided by the data signal. I_{Cdata} is depended upon a parasitic capacitance related to the sub data line and how it is laid in association with other metal lines associated with the corresponding pixel circuit. Here, the time for performing the charging process through the i-th sub data line is proximately the time for performing the extra charging process through the (i−1)-th sub data line. Optionally, using a simulation tool, both the first charging current Iₚ and the second charging current I_{Cdata} can be obtained. For example, a smartspice simulation software can be used.

Based on the charge conservation shown above, different pulse widths tᵢ of different data signals provided to respective sub data lines can be controlled to be correlated to each other in the following formula:

$$\frac{{t}_{i}}{{t}_{i - 1}} = \frac{{I}_{p}}{{I}_{p} - {I}_{Cdata}} \qquad ( 1 )$$

In other words, the method of providing the multiple data signals sequentially from 1 to n further comprises setting tᵢ/tᵢ₋₁ equal to a ratio of a first charging current over a difference of the first charging current and a second charging current. The first charging current is induced in a sub data line by the source driver. The second charging current is induced in the sub data line by the released charges from the parasitic capacitance associated with the sub data line. In an example, a group of sub data lines includes only two sub data lines, i.e., i=2, then the formula (1) has only one ratio of t₂/t₁, which is determined to be about 1.05.

In the embodiment, the i-th sub data line represents one of total n number of sub data lines in a group. Optionally, n is no greater than 6.

In an embodiment, the display panel for implementing the method described herein includes multiple pixels arranged in array of matrix having multiple rows and columns. Each group of sub data lines corresponds to one column of pixels, where each sub data line corresponds to a column of subpixels (usually of a same color), and all coupled to a single data line via a mux device. Usually, a pixel includes three subpixels, i.e., n=3. Or optionally, a pixel includes four subpixels, i.e., n=4. Optionally, two columns of pixels (and each pixel includes three subpixels) can share one mux device, thus n=6 in this case.

Referring to FIG. 4, optionally, the extra charging process applied to a pixel circuit through the i-th sub data line starts from an end time of the i-th pulse width tᵢ of the i-th data signal and ends with an extra time period after an end of a last pulse width tₙ of the n-th data signal applied to a pixel circuit through the n-th sub data line in a same group. Optionally, the extra time period after the last (n-th) charging process is set to 0.

In another embodiment, the method of providing multiple data signals comprises configuring the max device as n number of switches. Each of the n number of switches has a first terminal coupled to the data line and a second terminal coupled to a corresponding sub data line. The data line is connected to a source driver configured to generate a voltage signal with a fixed voltage level. The method includes turning on a first switch of the n number of switches for a first duration to pass the first data signal having the first pulse width equal to the first duration and a pulse height equal to the voltage level provided by the source driver to the first sub data line. Subsequently the method includes turning on a second switch of the n number of switches for a second duration to pass the second data signal having the second pulse width equal to the second duration and a pulse height equal to the voltage level provided by the source driver to the second sub data line. The first duration is controlled to be shorter than the second duration. More detail descriptions about configuring the mux device can be found below.

In another aspect, the present disclosure provides a driving circuit for using the method described herein to drive a display panel for displaying images. The display panel includes multiple groups of sub data lines. Each group includes multiple sub data lines respectively coupled to a data line. Each sub data line is coupled to a pixel circuit. FIG. 5 shows a schematic diagram of a display apparatus according to some embodiments of the present disclosure. Referring to FIG. 5, the driving circuit includes a source driver 700 configured to provide a voltage signal, multiple data lines 400 each of which connects to the source driver 700 to receive a voltage corresponding to the voltage signal, multiple mux devices 500 (one is shown) corresponding to the multiple data lines 400 (a corresponding one is shown). Each mux device 500 includes an input terminal coupled to a corresponding one of the multiple data lines, multiple output terminals each of which coupled to a sub data line, and multiple control terminals corresponding to the multiple output terminals. Each mux device 500 is configured to couple the multiple output terminals to a group of sub data lines in an one-to-one correspondence relationship.

Referring to FIG. 5, the driving circuit includes a control sub-circuit 600 coupled to the mux device 500 to provide multiple control signals applied respectively to the multiple control terminals of the mux device 500. Each control signal provided by the control sub-circuit 600 is configured to be applied to a control terminal to have an output terminal corresponding to the control terminal connected to the input terminal of the BMX device within a certain duration of time. The multiple control signals provided by the control sub-circuit 600 are configured to be applied sequentially in time to the multiple control terminals of the mux device 500. In particular, a first one of the multiple control signals received earliest in time by one of the multiple control terminals has a shortest duration of time.

In some embodiments, each mux device 500 includes n number of control terminals, where n is a natural number greater than 2. The multiple control signals received by the n number of control terminals sequentially in time include an (i−1)-th control signal provided to an (i−1)-th control terminal with a duration tᵢ₋₁ followed by an i-th control signal provided to an i-th control terminal with a duration tᵢ. The duration of time of the control signal provided at later time is longer than the duration of time of the control signal provided at earlier time, i.e., tᵢ>tᵢ₋₁, 1<i≤n. In particular, the first control signal applied at an earliest time to a first control terminal has a shortest duration t₁ among the n number of control signals applied respectively to the n number of control terminals. In some embodiments, each mux device 500 includes an input terminal configured to receive the voltage from a data line 400. Accordingly, an i-th output terminal of the mux device 500 is connected to the input terminal by the i-th control signal with the duration tᵢ to send an i-th data signal with a pulse width equal to the duration tᵢ and a pulse height equal to the voltage to an i-th sub data line.

Optionally, n is a natural number smaller than 7. In an embodiment, the display panel driven by the driving circuit described herein includes multiple pixels arranged in array of matrix having multiple rows and columns. Each group of sub data lines corresponds to one column of pixels, where each sub data line is coupled to a column of subpixels (usually of a same color), and all coupled to a single data line via a mux device 500. Usually, a pixel includes three subpixels, i.e., n=3. Or optionally, a pixel includes four subpixels, i.e., n=4. Optionally, two columns of pixels (and each pixel includes three subpixels) can share one mux device, thus n=6 in this case.

Optionally, the control sub-circuit 600 is configured to control durations of multiple control signals sequentially from 1 to n by setting tᵢ/tᵢ₋₁ equal to a ratio of a first charging current over a difference of the first charging current and a second charging current. The first charging current is induced in a sub data line by the source driver 700. The second charging current in the sub data line is induced by the released charges from a parasitic capacitance Cdata associated with the sub data line. The first charging current and the second charging current are obtained based on a simulation.

In a specific embodiment, the driving circuit of FIG. 5 is implemented to drive a display panel for displaying images using a method illustrated in FIG. 4. As shown in FIG. 5, a pixel of the display panel includes a first subpixel 100, a second subpixel 200, and a third subpixel 300. Each subpixel includes a pixel circuit. As an example, each pixel circuit is provided in a 2TIC structure, including a switch transistor STFT, a driving transistor DTFT, and a capacitor C. The switch transistor STFT has a gate coupled to a gate line, a first terminal coupled to a corresponding sub data line (e.g., a first sub data line 410), and a second terminal coupled to a gate of the driving transistor DTFF. The capacitor C has a first terminal coupled to the gate of the driving transistor DTFT and a second terminal coupled to a first terminal of the driving transistor DTFT. The first terminal of the driving transistor DTFT also is coupled to a high-voltage supply ELVDD. The driving transistor DTFT has a second terminal coupled to an anode of an organic light-emitting diode (OLED). OLED has a cathode coupled to a low-voltage supply ELVSS. Here the switch transistor STET is a P-type transistor. Thus, when a gate signal Gate provided to the gate line is a low-voltage signal, the switch transistor STET is turned on to make its first terminal connected to its second terminal. Alternatively, the switch transistor STFT can be a N-type transistor used with corresponding change in control signals provided to the gate line.

Referring to FIG. 5, the switch transistor STFT in the first subpixel 100 has its first terminal connected to a first sub data line 410. The switch transistor STET in the second subpixel 200 has its first terminal connected to a second sub data line 420. The switch transistor STET in the third subpixel 300 has its first terminal connected to a third sub data line 430. The data line 400 is coupled to a source driver 700 and the input terminal of the mux device 500.

Referring to FIG. 5, depending on the circuitry layout of the pixel circuit in each subpixel coupled to the corresponding sub data line, a parasitic capacitance C_{data} is induced in each sub data line. Assuming each subpixel has a same circuitry layout structure and similar transistor characteristics and the source driver provides a same voltage level to each sub data line through the mux device, the parasitic capacitance C_{data} in each sub data line is substantially the same.

During a process of driving the first subpixel 100, the second subpixel 200, and the third subpixel 300 together to emit white light, it is necessary to charge the gate N1 of DTFT in the first subpixel 100, the gate N2 of DTFT in the second subpixel 200, and the gate N3 of DTFT in the third subpixel 300 all to a substantially the same voltage V_{N0}.

The max device 500 includes a first control transistor SW1, a second control transistor SW2, and a third control transistor SW3. A gate of the lira control transistor SW is the first control terminal of the mux device 500. A first terminal of the first control transistor SW1 is the first output terminal of the inns device 500. A second terminal of the first control transistor SW1 is coupled to the input terminal of the mux device 500. Similar setups are formed for the second control transistor SW2 and the third control transistor SW3. Optionally, each control transistor is a P-type transistor shown in FIG. 5. Optionally, each control transistor can be a N-type transistor.

The control sub-circuit 600 is configured to firstly provide a first control signal applied to the first control terminal of the mux device 500, to make the input terminal to be connected to the first output terminal. Thus, a data signal originated from the source driver 700 can be passed through the data line 400 to the first sub data line 410. Particularly, control sub-circuit 600 is configured to control a first duration of time t1 of applying the first control signal to the first control terminal of the max device 500.

Subsequently, the control sub-circuit 600 provides a second control signal applied to the second control terminal of the mux device 500 with a second duration of time t2. The second control signal leads to a connection of the input terminal to the second output terminal. A data signal originated from the source driver 700 can be passed through the data line 400 to the second sub data line 420.

Lastly, the control sub-circuit 600 provides a second control signal applied to the third control terminal of the max device 500 with a third duration of time t3. The second control signal leads to a connection of the input terminal to the thud output terminal. A data signal originated from the source driver 700 can be passed through the data line 400 to the third sub data line 430.

In these operations sequentially in time, the control sub-circuit 600 is configured to control t3>t2>t1.

By simulations, after the duration of t₁, the gate N1 of the driving transistor DTFT in the first subpixel 100 is charged to a voltage V_{N1}. After the duration of t2 (which occurs after the duration of t1), the gate N2 of the driving transistor DTFT in the first subpixel 200 is charged to a voltage V_{N2}. After the duration of t3 (which occurs after the duration of t2), the gate N3 of the driving transistor DTFT in the first subpixel 300 is charged to a voltage V_{N3}>V_{N2}>V_{N1}. Referring to FIG. 4, from the end of the duration of t1 to the end of the duration of t3, an extra charging process occurs to further charge the gate N1 due to charge releasing from a parasitic capacitance C_{data} associated with the first sub data line 410. From the end of the duration of t2 to the end of the duration of t3, an extra charging process occurs to further charge the gate N2 due to charge releasing from the parasitic capacitance C_{data} associated with the second sub data line 420. With proper control the durations of t1, t2, and t3, after these extra charging process on top of the regular charging process induced by the corresponding data signals originated from the source driver, all the gates N1, N2, and N3 can be charged to the expected same voltage V_{N0}. In particular, V_{N3} can be controlled to equal to V_{N0}. V_{N2} and extra voltage increase due to extra charging process through C_{data} in the second sub data line can be controlled to V_{N0}. V_{N1} and extra voltage increase due to extra charging process through C_{data} in the third sub data line can be controlled to V_{N0}. Therefore, all OLEDs in respective three subpixels 100, 200, 300 can generate light emission with substantially the same intensity to obtain an ideal grayscale brightness for the pixel image.

Optionally, the control sub-circuit 600 is configured to control durations of multiple control signals sequentially from 1 to n by setting tᵢ/tᵢ₋₁ equal to a ratio of a first charging current in a sub data line induced by the source driver over a difference of the first charging current and a second charging current in the sub data line induced by the released charges from the parasitic capacitance associated with the sub data line. The first charging current and the second charging current are obtained based on simulations.

In another aspect, the present disclosure provides a display apparatus including a display panel and a driving circuit described herein. The display panel includes multiple groups of sub data lines. Each group includes multiple sub data lines. The driving circuit includes a mux device having multiple output terminals respectively coupled to the multiple sub data lines. The driving circuit also includes a control sub-circuit configured to provide multiple control signals sequentially to control multiple data signals to be sent to corresponding multiple sub data lines. One of the multiple data signals firstly received by one of the multiple sub data lines has a shortest pulse width.

In an embodiment, the display panel of the display apparatus is an organic light-emitting diode display panel.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A method for driving a display panel to display images, wherein the display panel comprises multiple groups of sub data lines, each group comprising multiple sub data lines and being coupled to a corresponding data line via a mux device, each sub data line being coupled to a pixel circuit, each data line being coupled to a source driver which is configured to provide a voltage signal, the method comprising:
providing multiple data signals originated from the voltage signal sequentially in time respectively to the multiple sub data lines in each group, wherein the multiple data signals includes a first data signal characterized by a first pulse width being received at a first time by a first sub data line in the group and a second data signal characterized by a second pulse width being received at a second time by a second sub data line in the group, wherein the first time is earlier than the second time and the first pulse width is smaller than the second pulse width.

2. The method of claim 1, wherein each group comprises n number of sub data lines, n being a natural number greater than 2, wherein the providing multiple data signals comprises providing an (i−1)-th data signal having a pulse width tᵢ₋₁ to an (i−1)-th sub data line of the n number of sub data lines followed by providing an i-th data signal having a pulse width tᵢ to an i-th sub data line of the number of sub data lines, tᵢ>tᵢ₋₁, 1<i≤n, wherein the first data signal provided at an earliest time to a first sub data line has a shortest pulse width tᵢ among the n number of data signals provided respectively to the n number of sub data lines.

3. The method of claim 2, wherein the i-th data signal, sequentially from 1 to n, is configured to induce a charging process to charge a gate of a driving transistor in the pixel circuit coupled to the i-th sub data line in a charging time equal to the i-th pulse width tᵢ followed by an extra charging process by released charges from a parasitic capacitance of the i-th sub data line, wherein the providing the multiple data signals sequentially from 1 to n comprises controlling the charging time of each data signal sequentially from 1 to n to obtain a voltage level at the gate of the driving transistor substantially same in each pixel circuit after the charging process induced by the n-th data signal ends.

4. The method of claim 3, wherein the providing the multiple data signals sequentially from 1 to n further comprises setting tᵢ/tᵢ₋₁ equal to a ratio of a first charging current in a sub data line induced by the source driver over a difference of the first charging current and a second charging current in the sub data line induced the released charges from the parasitic capacitance associated with the sub data line.

5. The method of claim 4, wherein setting tᵢ/tᵢ₋₁ comprises calculating the first charging current and the second charging current for each pixel circuit coupled to the i-th sub data line based on simulations.

6. The method of claim 2, wherein the n is smaller than 7.

7. The method of claim 1, wherein the providing multiple data signals comprises configuring the mux device as n number of switches each of which has a first terminal coupled to the data line and a second terminal coupled to a corresponding sub data line, turning on a first switch of the n number of switches for a first duration to pass the first data signal having the first pulse width equal to the first duration and a pulse height equal to the voltage level provided by the source driver to the first sub data line, and subsequently turning on a second switch of the n number of switches for a second duration to pass the second data signal having the second pulse width equal to the second duration and a pulse height equal to the voltage level provided by the source driver to the second sub data line, wherein the first duration is controlled to be shorter than the second duration.

8. The method of claim 3, wherein the extra charging process applied to a pixel circuit through the i-th sub data line starts from an end time of the i-th pulse width tᵢ of the i-th data signal and ends with an extra time period after an end of a last pulse width to of the n-th data signal applied to a pixel circuit through the n-th sub data line in a same group.

9. The method of claim 8, wherein the extra time period is 0.

10. A driving circuit for driving a display panel for displaying images, wherein the display panel comprises multiple groups of sub data lines, each group comprising multiple sub data lines respectively coupled to a data line, each sub data line being coupled to a pixel circuit, the driving circuit comprising:
a source driver configured to provide a voltage signal;
multiple data lines each of which connects to the source driver to receive a voltage corresponding to the voltage signal;
multiple mux devices corresponding to the multiple data lines, each mux device including an input terminal coupled to a corresponding one of the multiple data lines, multiple output terminals each of which coupled to a sub data line, and multiple control terminals corresponding to the multiple output terminals; and
a control sub-circuit configured to provide control signals to the multiple control terminals of the multiple mux devices to make the input terminal of each of the multiple mux devices being connected to the corresponding multiple output terminals for corresponding durations of time, wherein for each mux device, the control sub-circuit is configured to provide multiple control signals sequentially to the corresponding multiple control terminals, wherein a first one of the multiple control signals received earliest in time by one of the multiple control terminals has a shortest duration of time.

11. The driving circuit of claim 10, wherein each mux device comprises n number of control terminals, n being a natural number greater than 2, wherein the multiple control signals include an (i−1)-th control signal provided to an (i−1)-th control terminal with a duration tᵢ₋₁ followed by an i-th control signal provided to an i-th control terminal with a duration tᵢ, tᵢ>tᵢ₋₁, 1<i≤n, wherein the first control signal applied at an earliest time to a first control terminal has a shortest duration tᵢ among the n number of control signals applied respectively to the n number of control terminals.

12. The driving circuit of claim 11, wherein n is smaller than 7.

13. The driving circuit of claim 11, wherein the each mux device comprises an input terminal configured to receive the voltage from a data line, wherein an i-th output terminal of the mux device is connected to the input terminal by the i-th control signal with the duration tᵢ to send an i-th data signal with a pulse width equal to the duration tᵢ and a pulse height equal to the voltage to an i-th sub data line.

14. The driving circuit of claim 13, wherein the i-th data signal, sequentially from 1 to n, is to induce a charging process to charge a gate of a driving transistor in the pixel circuit coupled to the i-th sub data line in a charging time equal to the i-th pulse width tᵢ followed by an extra charging process by released charges from a parasitic capacitance of the i-th sub data line, wherein the control sub-circuit is configured to provide multiple control signals to control the charging time of each data signal sequentially from 1 to n to obtain a same voltage level at the gate of the driving transistor in each pixel circuit after the charging process induced by the n-th data signal ends.

15. The driving circuit of claim 14, wherein the extra charging process applied to a pixel circuit through the i-th sub data line starts from an end time of the i-th pulse width tᵢ of the i-th data signal and ends with an extra time period after an end of a last pulse width to of the n-th data signal applied to a pixel circuit through the n-th sub data line in a same group.

16. The driving circuit of claim 14, wherein the control sub-circuit controls durations of multiple control signals sequentially from 1 to n by setting equal to a ratio of a first charging current in a sub data line induced by the source driver over a difference of the first charging current and a second charging current in the sub data line induced by the released charges from the parasitic capacitance associated with the sub data line.

17. The driving circuit of claim 16, wherein the first charging current and the second charging current are obtained based on simulations.

18. A display apparatus comprising a display panel and a driving circuit of claim 11, the display panel comprising multiple groups of sub data lines, each group including multiple sub data lines, the driving circuit including a mux device having multiple output terminals respectively coupled to the multiple sub data lines.

19. The display apparatus of claim 18, wherein the driving circuit comprises a control sub-circuit configured to provide multiple control signals sequentially to control multiple data signals to be sent to corresponding multiple sub data lines, where one of the multiple data signals firstly received by one of the multiple sub data lines has a shortest pulse width.

20. The display apparatus of claim 18, wherein the display panel is an organic light-emitting diode display panel.
